(19) United States
(12) Patent Application Publication
(10) Pub. No.: US 2017/0206486 A1
(43) Pub. Date: Jul. 20, 2017

(54) SYSTEMS AND METHODS FOR ASSESSING VENUES

(71) Applicant: Montemare Pty Ltd, Hornsby, NSW (AU)

(72) Inventors: Kym Shilton, Hornsby (AU); Andrew James Marlow, Hornsby (AU)

(21) Appl. No.: 15/326,948

(22) PCT Filed: Jul. 17, 2015
(86) PCT No.: PCT/AU2015/050401

§ 371 Date: Jan. 17, 2017

(30) Foreign Application Priority Data
Jul. 17, 2014 (AU) 2014902762

(51) Int. Cl. G06Q 10/06

(52) U.S. Cl. CPC G06Q 10/06393

(57) ABSTRACT

Method and systems for assessing venues and events are described, the methods including the steps of: receiving data relating to a number of venues; processing the data to obtain values for each venue in relation to pre-defined factors, the factors including at least one economic factor, at least one social factor and at least one environmental factor; and providing an output which is based on values obtained for a particular venue and is also based on values obtained for other venues.

### TECHNICAL FIELD

The present invention relates to systems and methods for assessing venues such as sporting venues, hospitals, schools, commercial precincts and the like.

### SUMMARY OF THE INVENTION

In a first aspect the present invention provides a method of assessing a venue including the steps of: receiving data relating to a number of venues; processing the data to obtain values for each venue in relation to pre-defined factors, the factors including at least one economic factor, at least one social factor and at least one environmental factor; and providing an output which is based on values obtained for a particular venue and is also based on values obtained for other venues.

The at least one economic factor may include at least one financial factor.

The output may include a rating which is calculated based on a comparison of a value obtained for the particular venue with corresponding values obtained for other venues.

The output may include aggregated ratings which are calculated based on aggregated economic factors, aggregated social factors and aggregated environmental factors.

In a second aspect the invention provides a method of assessing an event held at at least one venue, the method including the steps of a method of assessing a venue according to the first aspect of the invention.

In a third aspect the present invention provides a system for assessing a venue including: means for receiving data relating to a number of venues; means for processing the data to obtain values for each venue in relation to pre-defined factors, the factors including at least one economic factor, at least one social factor and at least one environmental factor; and means for providing an output which is based on values obtained for a particular venue and is also based on values obtained for other venues.

In a fourth aspect the present invention provides a system for assessing an event including a system for assessing a venue according to the third aspect of the invention.

### BRIEF DESCRIPTION OF THE DRAWINGS

An embodiment of the present invention will now be described, by way of example only, with reference to the accompanying drawings, in which:

FIG. 1 is a schematic diagram of a system according to an embodiment of the invention;

FIGS. 2, 3 and 3A are examples of items of information which are entered by the users of the system of FIG. 1; and

FIGS. 4, 5 & 6 show metrics which are calculated from the information entered.

Appendix A shows an example of allocating scores to a metric; and

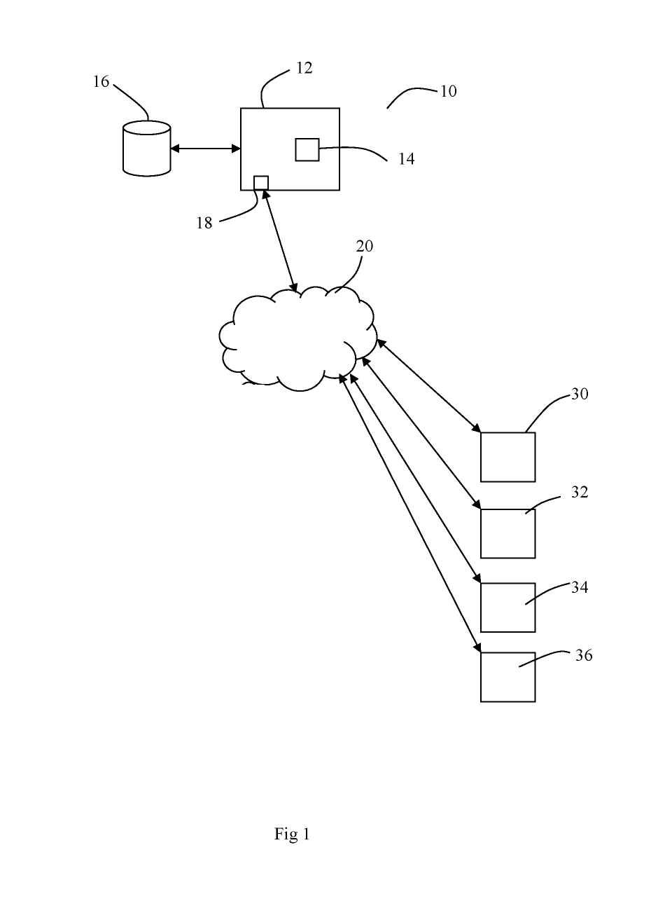

Appendix B shows an example of the output of the system of FIG. 1.

### DETAILED DESCRIPTION OF THE PREFERRED EMBODIMENT

Referring to FIG. 1, a system 10 is shown for assessing venues. The system 10 is embodied in an internet connected server computer 12 running suitably configured software under control of an operating system by way of a typical processor and memory architecture 14. Server 12 is connected to database 16 used for storing and retrieving information used in operating the system. Server 12 communicates via the internet 20 by way of router 18 to receive and transmit information used in the system as will be later described.

Operators of venues 30, 32, 34, 36 access server 12 by way of web browser software running on their own computing devices. System 10 receives information from the operators 30, 32, 34, 36 by way of them populating fields in an onscreen interface to answer onscreen requests for information. This may be in the form of a series of questions, or as a list of input fields and drop-down boxes which the operators can navigate and populate.

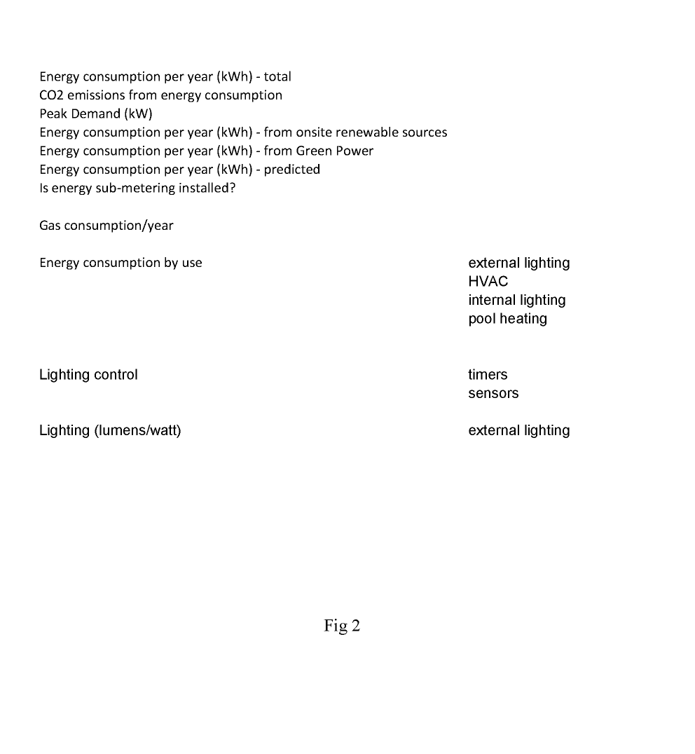

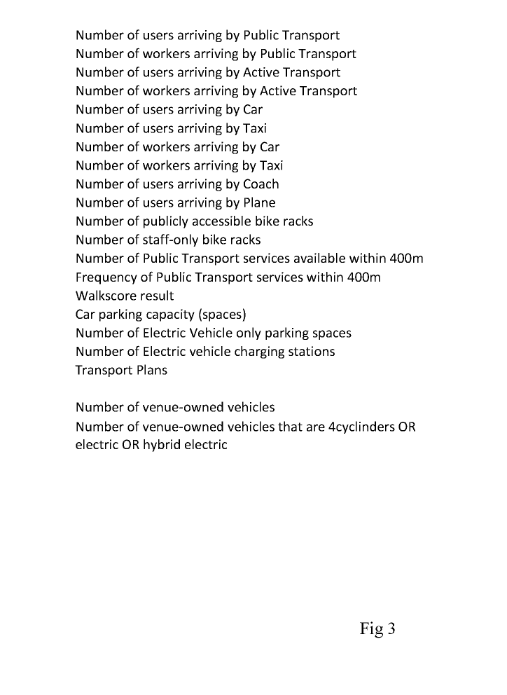

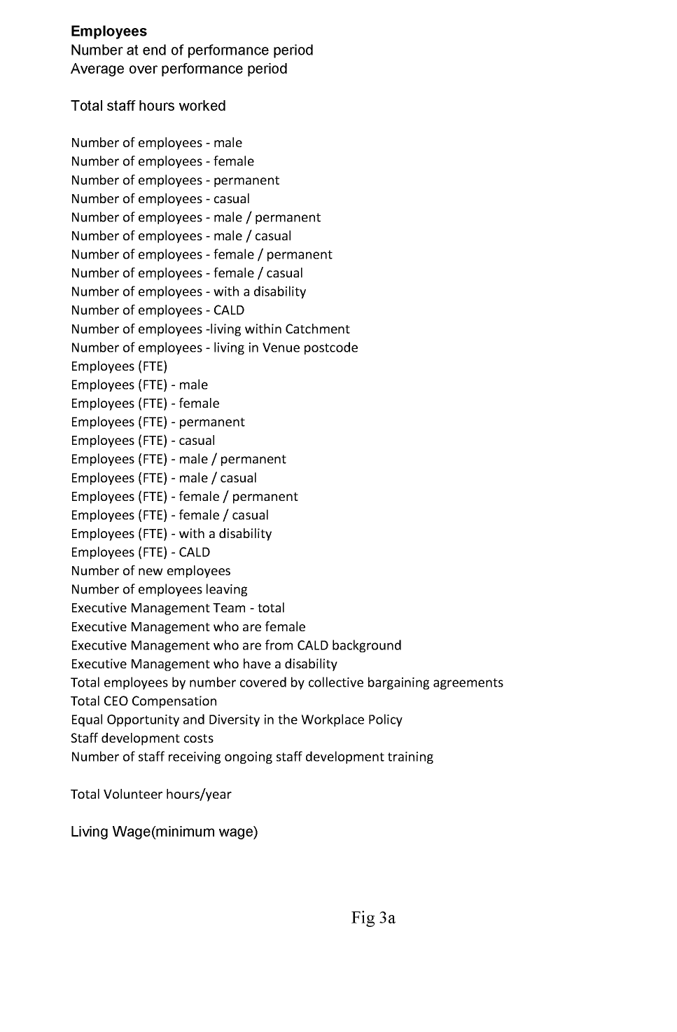

The information input by the operators is received by system 10 and stored in database 16. Examples of the information sought from operators are shown in FIGS. 2, 3 and 3A.

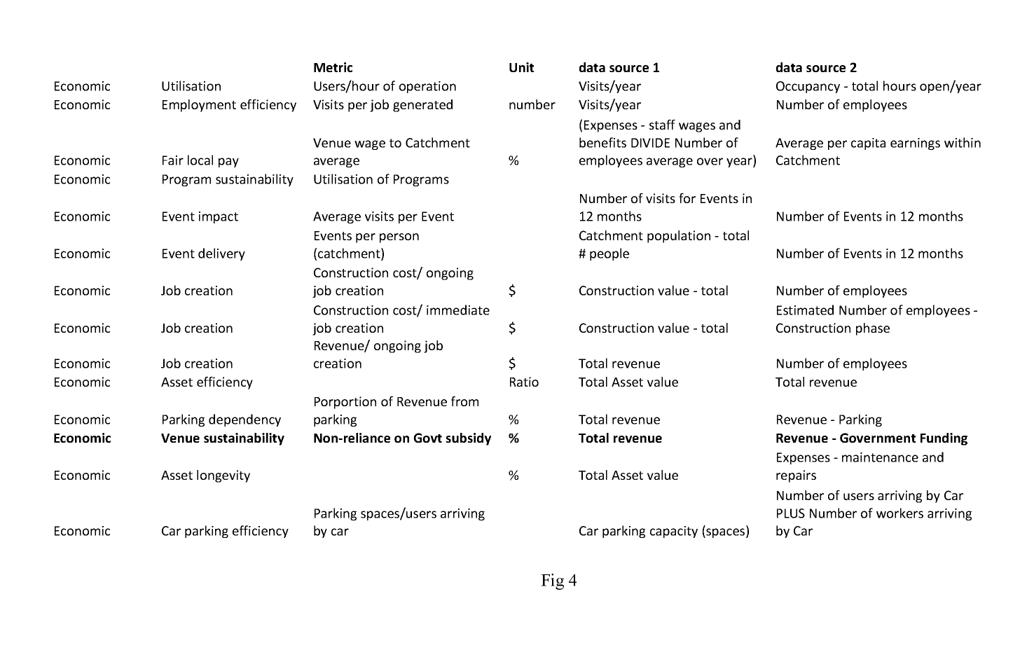

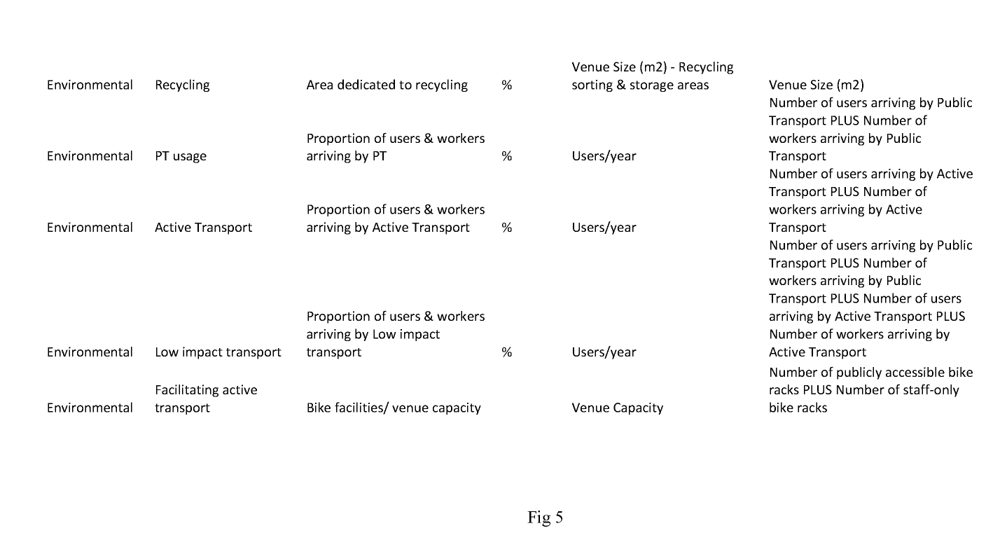

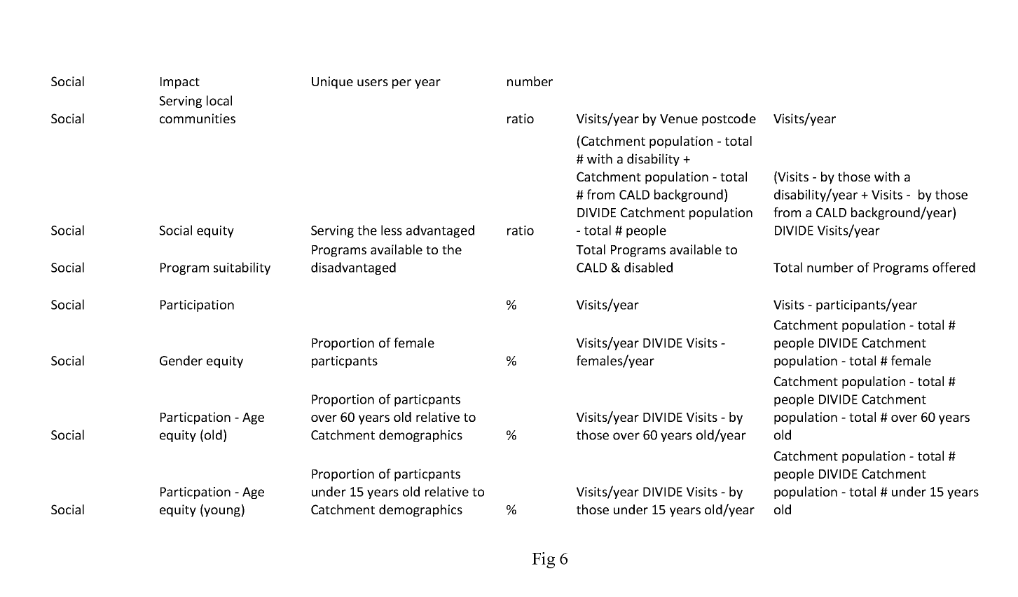

System 10 processes the data received from operators and obtains values for various aspects of the operation of the venue in the form of metrics. Examples of these metrics are shown in FIGS. 4, 5 and 6. The metrics are divided into categories relating to economic factors, environmental factors and social factors. The metrics shown in FIG. 4 are economic metrics, the metrics shown in FIG. 5 are environmental metrics and the metrics shown in FIG. 6 are social metrics.

Referring to Appendix A, each metric is allocated a benchmark score. An example is shown for the metric KWh hours per visitor. Firstly, the values obtained from all venues for this metric are averaged to arrive at an average value “X” for the metric. This average value is allocated a benchmark score of “5”. The remaining benchmark scores 0 to 10 are allocated based on deviations from the average in 10% increments. So, a value which is between 10% and 20% greater than the average is allocated a score of “6”.

The industry benchmark is always set at 5 and aligns to the average annual result. The increments of improvement and therefore relative score to the benchmark potentially changes year on year in line with expected continual improvement of the particular industry.

Referring to Appendix B, system 10 produces an output known as a “scorecard”. The scorecard shows all of the scores allocated to each metric. The scores are shown in categories “Economic”, “Environmental” and “Social”. Further, the scores in each category are weighted according to percentage weightings and added together to produce an aggregate percentage rating. The percentage rating is then converted to a Letter rating on the scale A to E according to the following ranges:

### A=90+%

### B=70-89.9%

### C=50-69.9%

### D=30-49.9%

### E=10-29.9%

The scorecard of Appendix A shows assessment results for the AAA Aquatic Centre. The venue has been assessed as rating D in the environmental category, rating C in the social category and rating C in the economic category. These ratings can be expressed together as a three letter code “DCC”.

The scorecard also shows the Industry Category Average (DCC) and Top Performer (BBC) Benchmarks. This allows an assessment to be made of the operation of the AAA Aquatic Centre compared to the industry as a whole by comparing the three letter codes.

The scorecard also shows the Venue Category Average (DCD) and Top Performer Benchmarks (BCC). This allows an assessment to be made of the operation of the AAA Aquatic Centre compared to other venues of the same type, i.e. aquatic centres.

Embodiments of the invention may be tailored to suit different types of venues. For instance, one embodiment may be tailored to sporting venues. Within that, sporting venues of various types may participate in the system although only some factors may be common to each venue. For instance, a variety of types of sporting venues may participate, such as swimming pools, football stadiums, and basketball stadiums.

The choice of information sought from the venue operators is configurable by the administrator of system 10. Similarly, the calculations used to arrive at the metrics, and how the metrics are allocated scores, how the scores are combined, and with what relative weightings, is configurable by the system administrator. The Metrics that form the ScoreCard remain consistent in each reporting period and in each embodiment. Metrics beyond the scorecard metrics may vary according to venue type.

Other embodiments may be tailored to assess healthcare venues, such as hospitals or medical centres or educational institutions, such as schools or universities or commercial developments such as retail precincts or office buildings.

In this document the terms “economic factors”, “environmental factors” and “social factors” are to be construed to include, but not be limited to the following:

Environmental factors—Resource Efficiency & Management—energy, water, air, materials use, Biodiversity—habitat, flora & fauna diversity & quality, Land use—space & place, construction & settlement, Waste—Landfill, Emissions and Pollution
Economic factors—Including but not limited to elements of economic and financial aspects:
Economy—Ecological efficiency & productivity, Job Creation and at Living Wages, Wealth Creation & Distribution, Labour & Welfare, Skills Development, Brand Value, Contribution to GDP/LGDP, R&D and Innovation, Local & SME Economic Development, Technological & Infrastructure Advancement
Financial—ROI, Long-term wealth creation, Economic Independence, Income & Expenditure Productivity, Revenue Effectiveness, Facility Effectiveness & Patronage, Customer Experience & Satisfaction, Staff Productivity, effectiveness and satisfaction, business maintenance and growth, market capture, asset management and effectiveness.
Social—Including but not limited to elements of Cultural, Social, Governance, Management & Politics:
Social & Cultural—Culture, heritage, identity and diversity, health & wellbeing, recreation and leisure, enquiry & learning, inspiration and creativity, social inclusion & capital building.
Governance—Ethical—fair, equitable, safe, accountability and integrity, human and cultural respect & dignity, lawful & just, Engagement—communication, involvement, representation, negotiation & mediation, Systems—Integrated & Holistic, Continual Improvement, Intergenerational equity, Risk Management and Compliance, Health & Safety effectiveness.

References to venues in this document are taken to include operational venues as well as venues which are proposed and therefore at design stage, or under construction.

Embodiments of the methods and systems described above can be used as a design rating system to rate a venue at design stage, before it has been built or commenced operation. The design rating system directly aligns to the scorecard and metrics of the operational performance assessment system. The systems comprises a series of questions related to design decisions and an assessment framework with respect to likely impact on the scorecard and metrics that determine the triple bottom line sustainability of a venue in operation. The system then simulates the results to predict the future operational performance of proposed new or refurbished venues.

The design rating system can therefore compare against the actual operational performance of other venues, as opposed to a straight line simulation of what is “technically” possible. This provides a more accurate predictor of future performance, as it takes into account the differences and unreliability of human behavior which heavily influences venue operations.

The design rating system compares to continually updated comparative results of the same type and sectorwide venues, through the operational scorecard and reporting systems.

Embodiments can be utilised in an event rating system which is hosted at one or more of the venues that have previously been assessed in the system. The event rating method and system can include the venues operational performance system, the design rating system, and also other non venue related elements of concern in a major event.

It can be seen that embodiments described above have at least one of the following advantages:
a comparative analysis framework is provided that permits comparisons between same-type venues and across a given sector as a whole regardless of physical location
Focus management efforts on the issues that yield the greatest results
Ability to compare venues of dissimilar types within the same sector

Any reference to prior art contained herein is not to be taken as an admission that the information is common general knowledge, unless otherwise indicated.

Finally, it is to be appreciated that various alterations or additions may be made to the parts previously described without departing from the spirit or ambit of the present invention.

APPENDIX A
Metric - KWh hours per visitor
Industry Benchmark - X Kwh per user
Venue Type Benchmark - XX Kwh per user

| Benchmark | 0 | 1 | 2 | 3 | 4 | 5* | 6 | 7 | 8 | 9 | 10 |
|---|---|---|---|---|---|---|---|---|---|---|---|
| Industry - | +50% | +40% | +30% | +20% | +10% | X | −10% | −20% | −30% | −40% | −50% |
| Energy Kwh | or | Energy | Energy | Energy | Energy | | Energy | Energy | Energy | Energy | or |
| per user | more | Kwh | Kwh | Kwh | Kwh | | Kwh | Kwh | Kwh | Kwh | more |
| | Energy | | | | | | | | | | Energy |
| | Kwh | | | | | | | | | | Kwh |

*X is the average annual result.

APPENDIX B B
2014 SUSTAINABILITY SCORE
VENUE NAME: AAA AQUATIC CENTRE
VENUE CATEGORY: AQUATICS
INDUSTRY CATEGORY: RECREATION & LEISURE
ASSESSMENT DATE: June 10^{th} 2014
ASSESSMENT VERIFICATION STATUS: Self or Independent Verification
INDUSTRY COMPARATIVE PERFORMANCE STATUS: DCC - compared to Industry Category Avg (DCC) and Top Performer (BBC) Benchmarks.
VENUE COMPARATIVE PERFORMANCE STATUS: DCC - compared to Venue Category Average (DCD) and Top Performer Benchmarks (BCC).

| SUSTAINABILITY | ASSESSMENT | | | | | | |
|---|---|---|---|---|---|---|---|
| PILLAR | CATEGORY | METRIC | WEIGHTING | | SCORE | | RATING |
| | | | | | | | Rating |
| ENVIRONMENTAL | Category | Metric | Weighting | | Score | | A/B/C/D/E |
| ECO-EFFICIENCY | Energy | kWh/user | 20% | 100% | 3 | 30% | D |
| | Water | KL/user | 10% | | 3 | | |
| | Procurement | % done sustainably | 10% | | 3 | | |
| | Refrigerants | Global Warming Impact - only if impact is significant | 10% | | 3 | | |
| | Low impact | Proportion of users & workers arriving by Low impact | 10% | | 3 | | |
| | transport | (foot, bike, PT) transport | | | | | |
| BIODIVERSITY | Urban Ecology | UHI score | 20% | | 3 | | |
| | Waste | kg waste to landfill/user | 20% | | 3 | | |
| | Innovation | | 0% | | 0 | | |
| | | | | | | | Rating |
| SOCIAL | | | Weighting | | Score | | A/B/C/D/E |
| EXPERIENCE | User Experience | results of satisfaction survey (% satisfied) | 10% | 100% | 5 | 53% | C |
| PATRONAGE | local users | % of visits by local (catchment) users | 10% | | 3 | | |
| EMPLOYMENT | Staff development | % of revenue spent on . . . | 10% | | 6 | | |
| | costs | | | | | | |
| HEALTH & SAFETY | Recommended | % of unique users achieving internationally recognised | 10% | | 2 | | |
| | activity levels | recommended physical activity per week | | | | | |
| | Fresh Food | % of food & beverage revenue from fresh food | 10% | | 5 | | |
| | Health & Safety | Number of Incidents/user + workers | 10% | | 7 | | |
| SOCIAL CAPITAL | Volunteering | volunteer hours/catchment population | 5% | | 3 | | |
| EQUITY & INCLUSION | Equitable Access | av entry cost/av (discretionary) income by catchment | 10% | | 8 | | |
| | (affordability) | | | | | | |
| | Social Inclusion | Team Sport Activities (particpant + spectator) per | 5% | | 4 | | |
| | | Catchment Population | | | | | |
| | | CEO to average worker pay. Ratio | 10% | | 6 | | |
| | Accessibility | % users by Target Group as proportion of catchment (by | 5% | | 3 | | |
| | | target group). Ratio between the two. | | | | | |
| | | Women in management positions | 5% | | 7 | | |
| INNOVATION | | | 0% | | | | |
| | | | | | | | Rating |
| ECONOMIC | | | Weighting | | Score | | A/B/C/D/E |
| RESOURCE | Patronage | Users/m2/year | 20% | 100% | 7 | 52.5% | C |
| PRODUCTIVITY | | | | | | | |
| | Venue Efficiency | # of Venue Components/Opening Hours/Programs/% | 10% | | 7 | | |
| | | Usage | | | | | |
| FINANCIAL | Revenue/Expense | Profit(or Cost Recovery)/user | 10% | | 5 | | |
| EFFECTIVENESS | effectiveness | | | | | | |
| | Financial | Non-reliance on Govt subsidy - % of total revenue from | 10% | | 3 | | |
| | Independence | govt sources | | | | | |
| | | ROI | 10% | | 3 | | |
| ECONOMIC | | Proportion of Expenses to local firms (within catchment) | 5% | | 6 | | |
| DEVELOPMENT | | | | | | | |
| | Job creation | Total Revenue/ongoing job creation (FTE) | 10% | | 6 | | |
| | | Avg non-management worker wage ratio to Living wage | 10% | | 5 | | |
| | | FTE employees in catchment/FTE employees in Venue | 10% | | 3 | | |
| GOVERNANCE | Governance | Management system &/or min. required | 5% | | 7 | | |
| | | policies/procedures in place to ensure continuous | | | | | |
| | | sustainability performance improvements? | | | | | |
| INNOVATION | Innovation | | | | | | |

1. A method of assessing a venue including the steps of:
receiving data relating to the actual operational performance of a number of venues;
processing the data to obtain values for each venue in relation to pre-defined factors, the factors including at least one economic factor, at least one social factor and at least one environmental factor; and
providing an output which is based on values obtained for a particular venue and is also based on values obtained for other venues; wherein the output includes a rating which is calculated based on a comparison of a value obtained for the particular venue with corresponding values obtained for other venues.

2. A method according to claim 1 wherein the at least one economic factor includes at least one financial factor.

3. A method according to claim 3 wherein the output includes aggregated ratings which are calculated based on aggregated economic factors, aggregated social factors and aggregated environmental factors.

4. A method of assessing a venue according to claim 1 further including an event held at the least one venue.

5. A system for assessing a venue including:
means for receiving data relating to the actual operational performance of a number of venues;
means for processing the data to obtain values for each venue in relation to pre-defined factors, the factors including at least one economic factor, at least one social factor and at least one environmental factor; and
means for providing an output which is based on values obtained for a particular venue and is also based on values obtained for other venues; wherein the output includes a rating which is calculated based on a comparison of a value obtained for the particular venue with corresponding values obtained for other venues.

6. A system for assessing a venue according to claim 5, further including a system for assessing an event.

7. A method of assessing a venue according to claim 2 further including an event held at the least one venue.

8. A method of assessing a venue according to claim 3 further including an event held at the least one venue.
